(19) United States
(12) Patent Application Publication
(10) Pub. No.: US 2008/0104976 A1
(43) Pub. Date: May 8, 2008

(54) METHOD AND SYSTEM FOR MONITORING A CRYOSTORAGE INSTALLATION

(75) Inventors: Cristiano GUGLIELMETTI, Piacenza (IT); Matteo POLESE, Milano (IT)

Correspondence Address: YOUNG & THOMPSON, 209 Madison Street, Suite 500, ALEXANDRIA, VA, 22314, US

(73) Assignee: AIR LIQUIDE SANTE (INTERNATIONAL), PARIS CEDEX (FR)

(21) Appl. No.: 11/923,005

(22) Filed: Oct. 24, 2007

(30) Foreign Application Priority Data
Oct. 25, 2006 (EP) 06122896.1

(51) Int. Cl. F25B 49/00; G01K 13/00

(52) U.S. Cl. 62/127; 62/129

(57) ABSTRACT

The invention relates to a method for monitoring and managing a cryostorage installation comprising at least one container or at least one refrigerator (3, 4), in which the samples to be stored are placed, in a refrigerated atmosphere, the said at least one container or refrigerator (3, 4) being placed in at least one room (A). According to this method, a monitoring is carried out, preferably remotely, with gathering of one or more data issuing from or representative of at least one container and/or refrigerator (3, 4) containing the samples, in order to check the state of the cryogenic fluid present therein, or of the electric power supply to the said container and/or refrigerator (3, 4), of the status of the means for opening/closing the said container and/or refrigerator (3, 4), or of the temperature prevailing in the said container and/or refrigerator (3, 4), of a cryogenic fluid feed line (2) connecting at least one reservoir (1) to at least one container and/or refrigerator (3, 4), to at least one valve arranged on the said feed line (2), or the said reservoir (118) containing the cryogenic fluid, of at least one ambient condition prevailing in the room (A), or of the stored samples. At least part of the data gathered are associated with the samples and stored in a manner associated with the samples. Associated system.

The present invention relates to a method and a system for monitoring and managing, particularly remotely, an installation for the cryostorage of biological or similar samples or material.

A cryostorage installation is an installation typically having one or more storage containers or vessels, and/or one or more mechanical refrigerators, wherein biological samples or products, such as cells, plasma, tissues, organs or other biological, chemical or biochemical and similar material are stored, in a refrigerating atmosphere obtained with a cryogenic fluid, such as liquid nitrogen or the like, or by means of a mechanical system, for example by means of freezers, or mechanical refrigerators with compressors or featuring another technology.

The container or vessel is supplied with cryogenic fluid issuing, via an appropriate feed line or duct, from a reservoir containing a cryogenic fluid, for example liquid nitrogen. Usually, one or a plurality of containers is further placed in a closed room, which is only accessible to authorized personnel and/or operators, particularly personnel wearing a key or an electronic access card (badge) which enables them to enter the said room

Furthermore, in the cryostorage room, detectors or sensors of ambient conditions, such as temperature, humidity, etc. are often present, suitable for determining whether the conditions prevailing in the room correspond to preset parameters in order to ensure optimal operation of the apparatus and to guarantee the safety of the operators and of the biological samples or products.

In such an installation, alarm instruments, such as flashing lights, audible or similar alarms, are also usually present, which are activated or are automatically tripped when a dangerous situation is detected, for example associated with a faulty operation or a malfunction of a container, or the detection of incorrect or faulty ambient parameters. This is described in particular in document WO-A-93/03891.

However, monitoring the ambient conditions or the access to the room is clearly insufficient to guarantee optimal preservation of the stored samples.

A real need therefore exists to be able not only to monitor the cryostorage installations, but also and, above all, to act immediately in response to the detection of a faulty datum or parameter, in order to permit optimal storage of the samples.

Document CA-A-2419647 teaches a cold room for storing products equipped with miscellaneous detectors for monitoring various parameters and for tripping an alarm, if necessary.

However, the present systems do not allow a knowledge of the complete record of a given sample, that is, to have a maximum of data relative to the life of the said sample, and therefore ensure effective traceability of each sample.

It is the object of the present invention to propose an improved method and system for monitoring an installation for the cryostorage of samples or other similar biological products, that ensures effective traceability of the samples stored therein.

In particular, an object of the invention is to propose such a monitoring system which takes account of the various units or devices for monitoring the cryogenic storage installations, which are currently independent of one another.

A further object is to propose a monitoring method and system of the abovementioned type which allows the gathering and storage of a plurality of data issuing from various monitoring units or elements of the installation, and a management of these data in automatic mode in order to generate an alarm appropriate to the gravity of the situation and, optionally, corrective measures in the installation, when these data do not correspond to preset parameters.

A further object is to carry out the monitoring and the management of the installation with a high level of safety, with regard to the communication of the data recorded during the monitoring, the resistance of the said monitoring devices to internal malfunctions and the resistance of the said monitoring devices of the storage installations to aggressive agents, such as dust, gas or moisture.

A further object is to propose a high security for data storage, including in case of generalized damage to the installation.

A further object is to propose a monitoring method and system of the abovementioned type allowing remote and/or local monitoring of the cryostorage installation via a plurality of communication systems, such as a PC (personal computer), cell phones, palm devices or the like.

A further object is to propose a method for crosschecking all the data relative to the cryostorage installation to check the quality of the storage of the biological samples or products.

A further object is to propose a monitoring system of the abovementioned type which can be extended to all the apparatus and the premises inherent in the cryostorage installation.

All or some of these objects are achieved thanks to a method for monitoring and managing a cryostorage installation comprising at least one container or at least one refrigerator, in which the samples to be stored are placed, in a refrigerated atmosphere, the said at least one container or refrigerator being placed in at least one room, in which:

a) a monitoring is carried out, preferably remotely, with gathering of one or more data issuing from or representative:
of at least one container and/or refrigerator containing the samples, in order to check the state of the cryogenic fluid present therein, or of the electric power supply to the said container and/or refrigerator, of the status of the means for opening/closing the said container and/or refrigerator, or of the temperature prevailing in the said container and/or refrigerator,
of a cryogenic fluid feed line connecting at least one reservoir to at least one container and/or refrigerator, to at least one valve arranged on the said feed line, or the said reservoir containing the cryogenic fluid,
of at least one ambient condition prevailing in the room, or
of the stored samples,

wherein at least part of the data gathered in step a) are associated with the samples and stored in a manner associated with the samples in order to know the record of each sample concerned and to be able to guarantee effective traceability thereof.

According to each case, the inventive method of the invention may comprise one or more of the following features:
the data gathered are sent to a unit of the management installation for determining the operating status of the installation and for taking action, preferably remotely, in case of malfunction,
the data gathered in step a) are stored in a database in which the samples are identified, listed and classed, thus creating a virtual direct link to the samples themselves.
a reading is made, preferably continuously, of the open or closed status of at least one valve, particularly a solenoid valve, or of a means for opening/closing the container and/or the refrigerator, particularly of the lid or the door of each container or refrigerator,
the ambient conditions prevailing in the room which are monitored in step a), are selected from the percentage of oxygen in the air of the room and/or the temperature in the room and/or the pressure in the room and/or the humidity of the room.
it is provided to activate an alarm when at least one of the data monitored deviates from an interval of preset values, the said alarm preferably being remotely activated by the remote management unit of the installation. The alarm may be an audible and/or visual alert, or may be an alert sent to the operator of the installation via an appropriate communication means, particularly a message sent to his mobile telephone, for example of the SMS (Short Message Service) type, an electronic message, for example of the email type sent to a computer or a telephone, or a conventional telephone call,
in addition, the access to the room where the container is placed is monitored using an access indicator present in the said room or in its environs, and/or the access to the samples is monitored,
each biological sample or product is associated with a code or a marking suitable for enabling its traceability, particularly in case of movement of the said sample,
the data exchanges and/or the communication between one or more measurement sensors and the remote management unit of the installation are carried out via an Internet, Ethernet or intranet network,
the data relative to the said monitoring are stored by the management unit in order, for each sample, to permit a retrieval of the record of the biological material stored and/or the conditions of its storage,
the remote management unit is suitable for acting independently on the installation in order to modify at least one of the said monitored parameters or data when a disagreement or a difference is detected between the recorded data of the said parameter and the preset data,

According to the case, the inventive system may comprise one or more of the following features:
the means for monitoring each container comprise level sensors suitable for recording the level of cryogenic fluid in the container, temperature sensors suitable for recording its temperature, and open/close sensors suitable for determining the opening of a container,
each container is associated with an identification and control device connected to at least one of the said sensors and to at least one control unit remotely connected to the remote management unit of the installation,
two redundant control units are provided, connected to a data transfer line to which the identification and control device is also connected,
in the room, means are provided for measuring the ambient conditions, particularly of the ambient air, preferably means are also provided for ventilating the said room, activable according to the recording of such conditions,
the measurement means are selected from an air pressure sensor and/or a temperature and/or humidity sensor and/or a sensor of the oxygen content in the air of the room where or close to the cryostorage containers are placed,
the measurement means are connected to the remote management unit of the installation,
the remote management unit of the installation is connected to at least one server suitable for gathering the data recorded in the containers and/or in the room where they are placed,
the remote management unit is connected to the server via a network connection, particularly of the Ethernet type,
the remote management unit may be a computer equipped with an Internet browser,
the data transmission means are designed and suitable for sending the data relating to the said monitoring, to the remote management unit in order to determine the operating status of the cryostorage installation and take action in case of malfunction or if the recorded data are different from the corresponding preset data,
it further comprises alarm means designed and able to trip an alarm or to deliver an incident fault datum when at least one of the checks performed by the remote management unit identifies an irregularity or a deviation from a preset state.
it comprises the additional step of generating an alarm or an incident fault datum when at least one of the checks of step a) identifies an irregularity or a deviation from a preset state,
in step a), a monitoring is carried out with gathering of one or more data issuing from or representative of the temperature prevailing in the said container or refrigerator and of the stored samples,
in step a), a monitoring is carried out with gathering of a plurality of data issuing from or representative of the stored samples, the data being selected from a description of the sample, an identification code or marking of the sample, the identity of any person having handled the sample, the date on which each sample handling procedure has taken place, a record of each operation or handling performed on the sample, a list of the product(s) used to treat the sample, the place of storage of the sample, a record of the temperatures of the sample with indication of any alarm trip, a record of the temperature lowering of the refrigerators/freezers in which the sample has been stored, and the sample shipment temperature measured at the time of delivery of the sample.

The invention also relates to a system for monitoring a cryostorage installation comprising at least one container and/or at least one refrigerator, in which the samples to be stored are placed, in a refrigerated atmosphere, the said at least one container and/or refrigerator being placed in at least one room, having limited and controlled access, comprising:
means for monitoring each container and/or refrigerator containing the said samples in order to check the state of the cryogenic fluid, the temperature in the said container and/or refrigerator, the line for feeding the said cryogenic fluid connecting a reservoir of cryogenic fluid to the said container and/or refrigerator, and the said reservoir of cryogenic fluid,
means for monitoring at least one ambient condition prevailing in the room,
and/or means for monitoring the stored samples, and
a remote management unit, and
data transmission means suitable for sending the data relative to the said monitoring to the remote management unit,

wherein the system further comprises means associating the recorded data with each sample and means for storing the data thereby recorded associated with the samples.

The present invention will be better understood thanks to the following description, provided for illustration but non-limiting, and with reference to the figures appended hereto, in which:

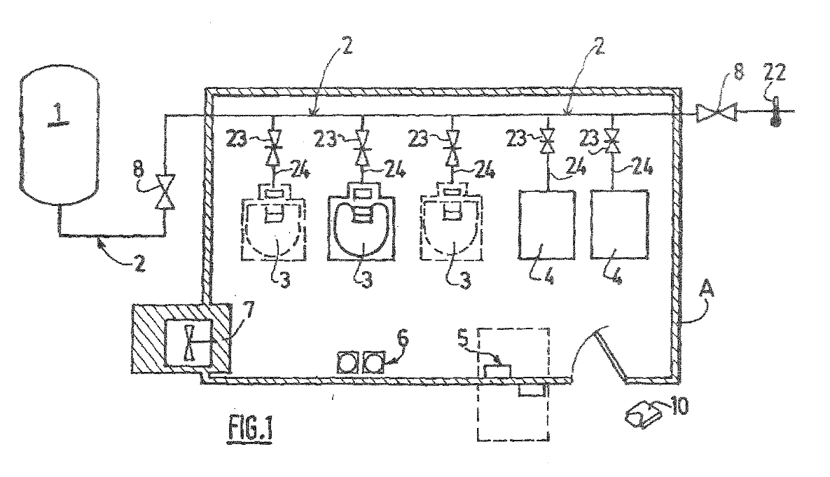

FIG. 1 generally shows an installation in which a monitoring system and method of the invention are used;

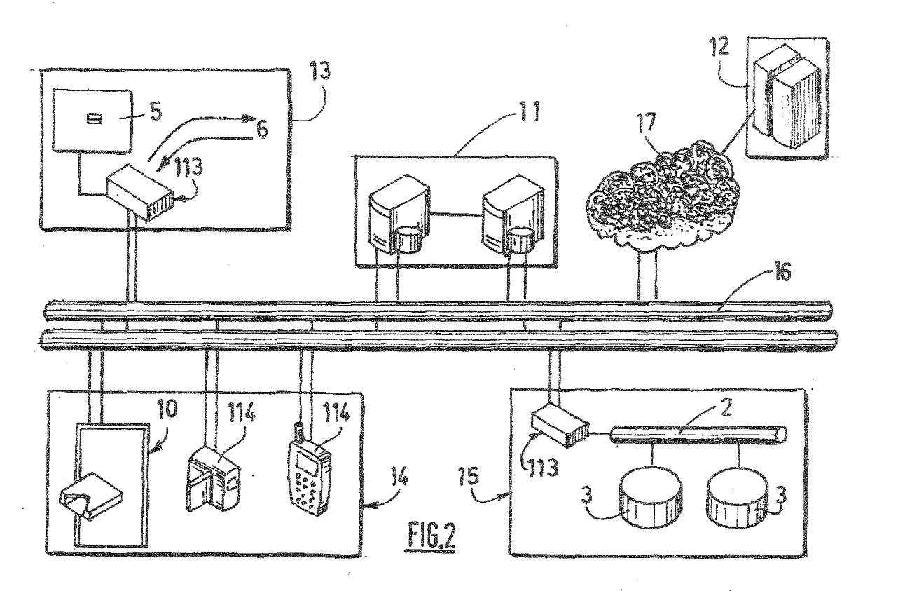

FIG. 2 shows a general view of the system used in the installation in FIG. 1;

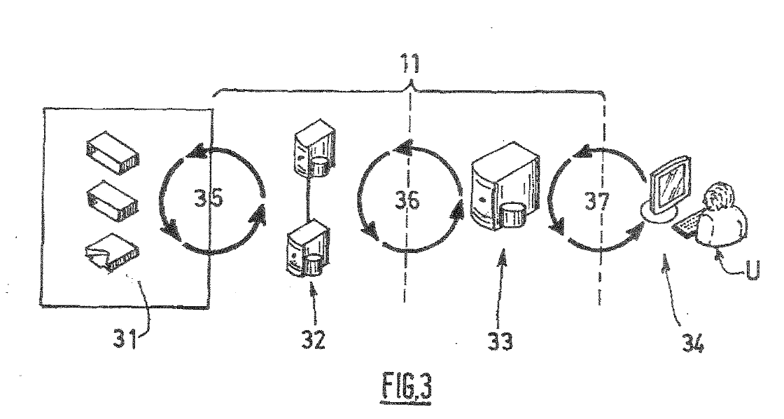

FIG. 3 schematically shows the monitoring system of the invention from the logic/functional standpoint; and

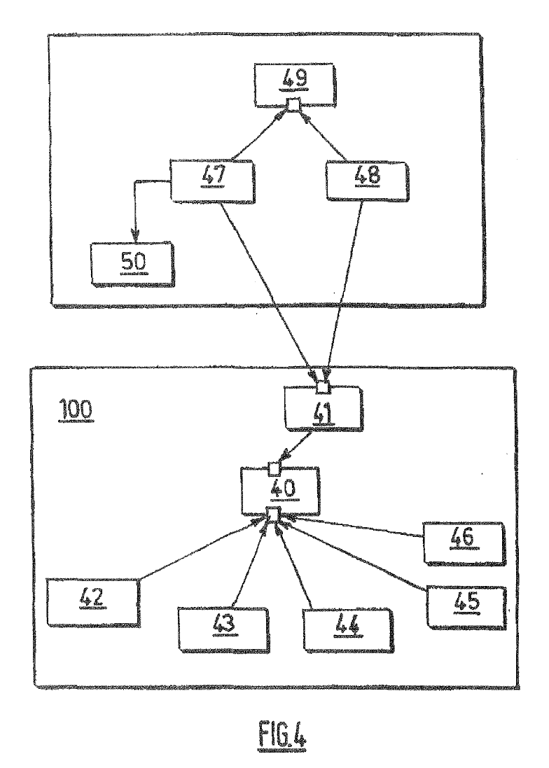

FIG. 4 shows a detailed block diagram of part of the system in FIG. 3.

FIG. 1 schematically shows a cryostorage installation according to the invention which comprises a closed, restricted-access room A wherein are placed the cryogenic containers 3 and mechanical freezers 4 containing the chemical, biochemical or biological samples and/or products to be stored.

For the purpose of simplification, in the context of the present invention, use is made of the generic term “samples” to denote the various biological, biochemical, chemical or other materials to be preserved, which are stored in the vessels 3 or refrigerators 4. The samples, after appropriate treatment, are stored in the container(s) or vessel(s) 3 or freezer(s) 4 until their sampling which may occur after a long period, for example, after months or years.

A cryogenic fluid is present in each cryogenic container 3, usually nitrogen at cryogenic temperature serving to maintain an appropriate temperature (for example <−150° C.) in the container itself for the preservation of the samples. The cryogenic fluid is stored in at least one reservoir 1 and is conveyed to the containers 3 via a cryogenic fluid feed line 2.

Also present in the room A are one or more mechanical freezers 4 or refrigerators for storing and/or freezing the samples by another preservation technique commonly used in a cryostorage installation. These freezers 4 may also use cryogenic fluid in case of malfunction of their refrigeration system and, for this reason, they are also connected to the line 2 to be supplied with liquid nitrogen issuing from the reservoir 1.

Cryogenic fluid is supplied to the two types of device 3, 4 by controlling a main valve 8 located on the line 2 and a relief valve 9 and feed valves 23 located on the connecting lines 24 connected, on the one hand, to each container 3 or to the mechanical freezer 4 and, on the other, to the nitrogen feed line 2.

To guarantee the safety of the personnel having access to the room A, particularly to limit the risks of anoxia associated with the presence of liquid gas, and to maintain the appropriate ambient parameters for handling the samples and for operating the apparatus present in this atmosphere, ambiance sensors 6 are preferably provided, connected to audible and visual alarm devices 5, which may be inside or outside the room 7, and to a room ventilation system 7.

In such an installation, it is absolutely vital to maintain the desired preset cryostorage temperature in each container 3 or freezer 4.

Moreover, concerning the cryogenic containers 3, it is important to always monitor the proper level of liquid nitrogen therein. This monitoring must be continuous and, preferably, without the dedicated personnel entering each room A where the containers 3 and/or freezers 4 are placed, and by minimizing the opening of the containers 3, in order to avoid the deterioration of the biological material therein, to prevent any contamination of the room A, while reducing the management costs of the installation 1 and preventing access to the room by unauthorized persons.

Furthermore, it is important to detect and rapidly solve any irregularities in nitrogen supply and the operation of the containers 3 or the freezers 4, and to maintain a record of all the parameters, particularly the ambient parameters, issuing from the devices and sensors 6, which participate in the proper preservation of the samples.

For this purpose, thanks to the inventive system, the data on each container 3 and freezer 4 and from each sensor 6 present in the room A, can be gathered, and action can then be taken to avoid jeopardizing the biological material of the samples.

For this purpose, as illustrated in FIG. 2, the following are used:
a plurality of sensors 6 and couplers 113, present in the installation, which are devices translating the signal from the sensors 6 into a network protocol (blocks 13 and 15);
devices for monitoring access, such as a reader of a badge 10, code or a biometric recognition device, and for monitoring the actions performed in the room (block 14);
a control centre 11, connected thereto via a data network 16, such as an Ethernet network, where the data recorded are gathered and processed, and in which actions are automatically triggered in aiming to solve any problems that may arise during the cryostorage of the material;
one or more main servers 12 may be (if required) connected to the control centre 11 via a data network 17, in which the data gathered are stored and which manages the interface with the user.

In particular, the control centre 11, connected to each main server 12, performs the following functions:
gathering and storage of data from the field devices, that is from the sensors and other abovementioned devices;
execution of actions on the field devices on behalf of an operator or automatically in response to the overrun of a threshold value of a parameter monitored by the said devices;
generation of critical alarms to the personnel or the operator by GSM (SMS), E-mail, WEB and voice;
supply of a supervision interface based on network technologies (Web) usable both by Internet and on an intranet.

Furthermore, in order to guarantee service continuity, the supervision system fulfils the following service needs:
Upgrading: it is possible to add servers in operating equilibrium to make the response time of the control centre 11 nearly constant faced with an increase in operations;
Reliability, availability: the operability of the system is a guarantee even in case of damage to one of its components, thanks to the use of the following technologies:
Support of redundancy of the servers and of the application services;
Redundancy of network connections (network plugs, switches, signal converters, access points for wireless connection);
Load balancing allowed by the redirecting of the requests from the various units or sensors connected to a server available in case of degradation of one of the servers;
Interactivity with the apparatus already existing in the installation and other apparatus which may be added thereto, based on current or future standards.

The data network 16 is based on the Ethernet technology. This permits an optimal link between the various points of the installation and the control centre 11, and inter alia, permits a rapid connection and activation of the various components of the system according to the invention with the said centre 11, a substantial simplification of the remote technical action on the various components of the system, high flexibility of the installation insofar as new members (sensors and devices) can be connected to the system rapidly without a negative impact on the operation thereof and on the members previously present. This network topology also permits a rapid link with an existing intranet network, for example of a hospital.

The system according to the invention is subdivided logically into four logic areas, shown in FIG. 3. The subdivision is purely logic/functional and does not necessarily reflect the hardware actually used, which is described in detail below. According to this subdivision, the said system comprises the following areas:
FIELD DEVICES: area 31 comprises all the devices constituting the instrumentation of the cryostorage installation 1 and of any communication interfaces thereof.
FIELD AUTOMATION: area 32 comprises one or more field supervisors in a redundant configuration, and serves to automate the devices and the data gathering.
MAIN DATABASE: area 33 comprises one or more servers 12 equipped with a main database and appropriate multichannel communication systems, for the historical consolidation of the data and the management of the services of the user U interface.
USER INTERFACE: area 34 comprises computers or portable devices permitting the operability of the users U on the cryostorage installation 1.

These four levels communicate together via three communication systems shown schematically in FIG. 3:
AUTOMATION CONTROLS 35: these serve to gather and to send the data and its indications by the devices and the interfaces, the data for management of the automation of the installation and for gathering the data.
DATA GATHERING 36: this serves to manage the data communication of the field supervisors and the installation configuration.
INTERFACE SERVICES 37: these serve to manage the multichannel interface of the main database with the user U.

The level relative to field automation 32 and the level relative to the main database 33 represent the logic control centre 11 of the entire system of the invention.

Each level is characterized by a plurality of method algorithms (software) of various types, described in detail below.

Level n. 1: FIELD DEVICE

This logic area 31 deals with gathering the physical signals issuing from the field or from the various sensors (13-15) and control devices 11, and converting them via appropriate low logic level couplers, into data intelligible at the higher logic levels and vice versa, converting the actions ordered by the supervisor levels into signals intelligible by the devices and by the field actuators.

Specific low-level couplers are used for managing these automation functions, which concern the safety of the operators in the installation or which are considered critical according to the proposed objectives of the installation. These are programmed via a PLC (programmable logic controller) logic to guarantee their operation, even in case of serious malfunction of the higher level logics.

At least one coupler is normally present, programmed so that, installed on the field device for monitoring the ambient parameters (ambient sensor 6), it follows the following sequences:
permanently check that the supervision system is active: surveillance function;
check that the oxygen level does not fall below two critical thresholds, for example 19% and 17%; and
generate an audible alarm via a sound frequency modulation of a sound generator (off 1 Hz, 2 Hz, continuous sound)—of each alarm device 5—when the supervision system remains inactive and the oxygen level in the room A, monitored by the sensor 6, is below the critical thresholds.

Also at this level are field devices that have an evolved communication protocol and which are capable of communicating with the higher level directly or via a protocol coupler. Such devices may, for example, be the supervision electronics of the cryogenic vessels 3 or refrigerators 4, as well as centrifuges or laboratory incubators.

Level n. 2: FIELD AUTOMATION

This logic area 32 contains all the automation data processes of the field devices. In particular these components are shown schematically in FIGS. 3 and 4, and comprise:
the CryoFieldManager 47 having the following functions:

either interrogation (pooling) of the field devices to retrieve the data therefrom based on the configuration read by the main database 40 (area 33 described below) or adjourn the monitoring contactor of a device 37 capable of performing the ambient inspection to enable independent alarm generation by the device (via a corresponding alert device) which may relate to the safety of the users in the installation (for example low oxygen levels) or which are considered critical according to the preset objectives of the installation, in case of malfunction of the supervision system;
or adjourn/control a surveillance time-lag shared with the CryoFieldManager 47 in active/passive mode to generate the redundancy of the service;
Store the field data in a field database 49 of the field devices;
Run actions on the field devices, imposed by the operator or in automatic mode and generate alarms.
CryoLocalExchanger 48 with the following functions:
replicate the data on the field devices and alarms, incorporated in the database 49 of the CryoFieldManager 47 service, in the main database 40;
transfer the actions on the field devices imposed by the operator from the main database 40 to the database 49;
restart the CryoFieldManager 47 service in case of change of the configuration or of the field parameters.

The database 49 is the support database connected to this logic area 33. It contains the data read by the CryoFieldManager 47 service by the field devices and the current field configuration.

Communication via a CryoDBInterface 41 logic area from the supervisor 100 is a service via Internet or network (service web) used by the CryoFieldManager 47 service and CryoLocalExchanger 48 to access the main database 40.

All the components making up this area are always redundant: hence there are always at least two methods of this type for each installation and as many databases 49, of which at least one is active; the others, which are passive, continuously check the functionality of the active process(es), ready to be activated in case of failure of the system, by tripping a malfunction alarm at the same time.

Level n. 3: MAIN DATABASE

This logic area 33 gathers all the data recorded by the databases 49 and consolidates them in the main database 40 permanently; and vice versa, as mentioned above, restores the usual configuration and the actions commanded by the operator on the database(s) 49.

It also manages the services (interfaces services) permitting the interface with the user. This database also contains all the commands and actions entered by the user.

The communication system via the areas 32 and 33 (“Data gathering” 36 in FIG. 3) is based on an evolved and asynchronous protocol, that is which guarantees the integrity of the data and which also functions in case of an interruption in communication via the levels 32 and 33.

More particularly, the area 100 in FIG. 4 comprises the following components:
CryoDBInterface 41 is a service by Internet or network (service web) used by the CryoFieldManager 47 and CryoLocalExchanger 48 services to access the main database 40;
CryoSMTPGateway 45 is an algorithm which retrieves, from the main database 40, the alarms to be sent via e-mail, and sends them to an SMTP server;
CryoPhoneCell 46 is an algorithm which retrieves, from the main database 40, the alarms to be sent via SMS or voice, and sends them to the SMS dispatching system or a voice messaging system.

Level n. 4: USER INTERFACE

This logic area 34 summarizes all the communication strategies with the user. The main interface with the user is based on the web and can operate via any computer or PC provided with a standard Internet browser. The access policy to user interfaces is based on user profiles: a user is only authenticated once and only accesses the functionalities for which he is authorized. The level of authorization is linked to the kind/types of samples stored and/or processed.

Every action, activation or modification performed by the user is traced in the system. The functionalities of the main interface are explained to the user via three application areas of the supervisor 100:
Control panel 42: network application accessible by Internet or intranet which enables the operators to monitor the status of the field devices, execute actions and display active alarms.
Sample management 43: network application accessible by Internet or intranet enabling the users to display the record and movements of the cryostored samples.
Administration 44: network application accessible by Internet or intranet which enables the administrators to display the monitored devices, their typology and their parameters.

Also forming part of this area 34 are the interfaces pre-assigned to portable devices (PDA or the like) for the entry and display of the user data of the wireless channels.

Logic Architecture of the Installation

The logic architecture of the invention described above can be demonstrated, in various ways, in the devices installed in the cryostorage installation. The physical configuration of the installation is in fact determined not only by the devices present in the installation but also by the redundancy and service level requirements necessary for the objectives in the installation itself.

Concerning level 31, it is normally implemented via the following devices:
A/D (analogue/digital) signal acquisition and control stations: based on PLC couplers they permit the acquisition and checking of the field A/D signals. These may also integrate audible and light signals, and implement autonomous functionalities;
Serial/Ethernet coupling stations: based on low level protocol couplings, permits the translation of the protocols based on the serial network on the Ethernet network.
Electronic card or proximity badge reader, to authorize access to the room to authorized persons only. To reinforce security at the entrance, it is possible to require the user to enter a code and/or perform a biometric recognition of his thumb.
Telecamera, with presence indicator, acquiring the images of each action performed on the devices present in the room. The operating logic of these two devices is managed by the central supervisor, connected thereto by Ethernet network.

In the typical configuration of a cryostorage installation, of which the main components have been described above, level 1 is structured as follows:
for each branch or connecting line 24 of the nitrogen feed line 22, two control stations and A/D signals are provided for managing the cooling of the connecting line 24, and two Ethernet serial coupling stations for the translation of the signals;
for each room A, at least one A/D signal control station is provided for monitoring the atmosphere of the room, at least one badge reader 10 and at least one webcam 114 connected to the network 16;
for each nitrogen reservoir 3, one A/D signal control station is provided for determining the level and pressure of the reservoir itself;
the levels or areas 32, 33, 34 can be implemented on one or more physical devices provided that they have the functionality of a computer (PC).

The typical configuration is shown in FIG. 3:
level 32 is preferably installed on two or more industrial PCs, designed to withstand dust and rain, placed in the vicinity of the installation;
level 33 is preferably installed on two or more servers, equipped with at least duplicated power supply and bulk storage devices. It may also be placed in a site at some distance from the installation 1, connected to the system via any Internet type network infrastructure;
level 34 is obtained via stationary PCs or laptop PCs placed at the entrance of the cryostorage installation;
the data network 26 connecting the various devices is of the Ethernet type or leading to Ethernet via appropriate couplers 113;
the network interconnections are structured so that each device can be reached via at least two distinct and independent network pathways (cf. Ethernet 1 and 2 in FIG. 2);
in general, the configuration may be entirely duplicated/redundant, in full or in part, according to the client's requirements, to guarantee the availability of the application in agreement with the objectives under cryostorage installation.

The operation of the system of the invention will now be described in the context of a typical cryostorage installation, shown schematically in FIGS. 1 and 2, in order to explain how the logic and physical interfaces can be installed.

FIGS. 1 and 2 show part of an installation comprising in particular the containers or vessels 3 and the mechanical freezers 4 in which the biological material to be stored is placed. As mentioned above, the containers 3 receive liquid nitrogen from a reservoir 1 via a feed line 2. Each of the said containers 3, reservoir 1 and line 2 is monitored by the control centre 11 in order to maintain, for the biological material, optimal conditions for its preservation overtime (even prolonged).

More particularly, each container or vessel 3 is equipped with dedicated sensors (not shown) suitable for reading the nitrogen level inside, the temperature, the status of the lid and the container feed solenoid valve.

Each container 3 is also equipped with a control device which is connected to the said sensors, which gathers the data from the said container and releases it to a network interface which is typically, but not necessarily, serial asynchronous, which may be connected in cascade to a plurality of containers, thereby forming a chain. Two couplers are connected to the end of this chain, the first being the CPU which, while the second (backup) acts in case of damage to the main CPU, guarantees the continuity of data acquisition from the devices.

In order to fill the container 3 with nitrogen in the liquid phase, the main coupler may (if required) also manage the cooling of the nitrogen line 2, being connected to a solenoid valve 23 and a temperature sensor (not shown) arranged on the said line. When a container 3 needs to be filled with cryogenic fluid, the solenoid valve 23, arranged at the end of the feed line, opens and allows the gas phase fluid to escape to the external atmosphere. When the temperature read by the sensor falls below a value compatible with the presence of liquid phase cryogenic fluid, the solenoid valve 23 is closed. To optimize the consumption of cryogenic fluid, the system orders the filling of all the devices (3-4) present on the line 2.

In the room A, an A/D (analogue/digital) signal acquisition and control station 13 is connected to the oxygen and/or pressure and/or temperature and/or humidity sensors 6. It also serves to monitor the audible and light alarm devices 5, to monitor the conventional ventilation devices of the room 7, and to control the main solenoid valve 8. In particular, the volumetric percentage of ambient oxygen must be monitored continuously. The system permits the imposition of two alarm thresholds, and typically a non-critical alarm threshold (%<19%) is imposed and a critical alarm threshold (%≦17%).

If the oxygen content reaches the 19% threshold, the A/D signal acquisition and control station 13 activates the ventilation device 7 to obtain the maximum air renewal; and a local alarm, visual and/or audible 5, is activated and alerts the personnel. The alarm condition disappears when the content returns to a normal level (above 19%).

If the oxygen content falls below 17%, the high speed ventilation is confirmed and the main liquid nitrogen feed solenoid valve 8 is closed; and a local alarm, visual and audible 5, is activated to alert the personnel.

The system continuously records all the ambient parameters: all the data gathered are sent to the control centre 11 and then stored in the main database. The couplers are connected to other couplers, via connecting members, and are thereby connected to a programmable unit for monitoring the data of room A, which is itself connected to the centre 11.

The system continuously monitors the pressure and level of the feed reservoir 1 using readout means mounted on the reservoir. The data are sent to the control centre 11 via a series of appropriate couplers.

When the level reaches an attention level, an alarm is tripped to inform the users of the need for filling. This alarm is normally also sent to a cellular device (not shown) of the persons responsible for filling the feed reservoir 1 with cryogenic fluid.

The system also activates alarms in case of critical level and pressure values, which are the indications of a potential malfunction of the cryogenic fluid distribution system. The system permits continuous monitoring of the nitrogen level and the temperature of the cryogenic containers and at least of the temperature of the mechanical technology containers and the appropriate activation of the solenoid valves 23 for filling the reservoirs with cryogenic fluid.

The liquid nitrogen level is continuously read by a dedicated probe in the cryogenic containers 3. It responds in active mode to any filling levels outside critical values, by activating the automatic filling of the container.

All the data gathered are sent to the control centre 11 and then stored by the main database of the server 12. Appropriate level and system malfunction alarms are provided with organization of critical level thresholds, which form the filling function for the automatic filling system.

For example, assuming that the loading start and end levels are 60% and 80%, the steady state thresholds may be:
minimum level alarm—non-critical: % 5% lower than the loading start level;
super minimum level alarm—critical: % 10% lower than the loading start level;
maximum level alarm—critical: % 5% higher than the loading end level;
super maximum level alarm—critical: % 10% higher than the loading end level.

When the loading start level is reached (e.g. 60%), the automatic filling begins via an opening of the container filling solenoid valve 23. The solenoid valve remains open until the final loading level is reached (e.g. 80%), and the solenoid valve closes when it is reached.

In the case of mechanical refrigerators 4, the nitrogen feed is optional and only used in case of malfunction of the mechanical cooling system, and arrives via the feed solenoid valve 23. Other cryogenic fluids may be used for this purpose instead of liquid nitrogen.

Monitoring the temperature allows the continuous recording of the temperature values read by the probes dedicated to the cryogenic containers 3 and the mechanical freezers 4 and the loading of cryogenic fluid in case of temperature below the alarm threshold.

Two alarm thresholds are set, for example: non-critical threshold: T>−145° C. and critical threshold: T>−135° C.

All the data gathered are sent to the control centre 11 and then stored in the main database 12. Appropriate temperature and system malfunction alarms are provided with setting of critical temperature thresholds, which perform the cooling function for the automatic filling system.

The system also provides for monitoring and timing the status of the lid (open/closed). The data relative to status changes of the lid are recorded and stored to permit the traceability of the movements of the samples contained therein. The system provides for activating an open lid alarm.

Finally, the system serves to directly monitor the status of the container filling solenoid valve, that is, open or closed.

To feed liquid nitrogen promptly to the containers 3 and the freezers 4, appropriate monitoring is provided of the main solenoid valve 8 arranged between the reservoir 1 and the cryostorage containers. The said valve is normally closed but a manual bypass is nevertheless available, to be used in case of voltage drop. There may be a cascade of main solenoid valves, depending on the topology of the installation.

The system, via suitable signal couplers, manages the opening/closing of the reservoir solenoid valve in the following cases:
closure: the percentage oxygen recorded by any of the recording devices falls below a preset value, for example 17%;
closure: if the level of the super-maximum level alarm is reached;
closure: manual action in case of loss.

The system reopens the solenoid valve 8 if the abovementioned parameters return to normal or in case of manual action.

The system continuously records the status of the main solenoid valve 8. All the data gathered are sent to the control centre 11 and then stored in the main database 12.

Thanks to the invention, it is possible to supervise a cryostorage installation optimally, even remotely, by monitoring the parameters specific to each container 3, 4 suitable for permitting such a storage, the ambient parameters, and also the access to each container and to each room where the biological material in the preservation phase is stored.

The system is connected to an intranet/Internet network and is provided with a specific data access protection architecture (firewall). This can be accessed by using an Internet browser.

The system automatically modulates its functionalities according to the authorization of the connected user, independently of the user platform, without requiring the installation of specific software. This is optionally open to communication with other national and translational information systems, via a dedicated interface.

All these features are fully usable by each PC networked with the main server 12.

It is also possible to provide display locations in the control rooms equipped with a card reader (badge) to accelerate the user authentication operations. For distant locations, authentication preferably occurs via the username and password.

The system therefore serves in particular to:
display the parameters relative to the samples themselves, stored in the installation;
display the topographic mimic panel of the room, which summarizes the main parameters recorded by the containers, by the mechanical freezers, or by the ambient recording points and by the ventilation system;
display the alarms;
display the actions performed on the samples: placement, processing, retrieval, movement; and
display the statistics and multidimensional reports.

Furthermore, according to a preferred embodiment, a specific identification code can be associated with each sample, for example, a barcode or any other marking or identification means suitable for identifying the sample concerned, such as a microchip or similar.

Such a code refers, for example, to the position of the biological material in the room A, particularly a code which takes account of the container, support, level, box, row/column position in the box, visiotube, palette, etc.

Thanks to this coding, an operator, after having identified himself via the personnel card or badge and code (password), can easily receive data on the position and on the typology of the sample or samples requested. During the retrieval or immersion of the sample, the user must co-validate the containers via a code reader as the samplings are made, receiving confirmation from the system and visual data on how to proceed. This makes it possible to record any movement of the biological sample or material.

Furthermore, the system associates, with the sample, all the data gathered in the installation related to the sample itself. This makes it possible to retrace the complete storage record of the sample.

In other words, thanks to the data gathered by the method or system of the invention, it is now possible to track the record of each sample by storing all the events which have marked the life of the sample concerned, and in particular, it is now possible to identify the vessel in which it has been stored (identification of the vessel and of its position in the said vessel, the room, the hospital, etc.), how much time (date of introduction and/or exit from the vessel), under which conditions (temperatures, nitrogen levels, alarms tripped or not, opening of the vessel, etc.), by whom it has been handled and when (person authorized with access by badge or similar, etc.).

All these data of the sample record can be stored in a database in which the various samples are identified, listed, classed, etc., in association with all the data concerning the record. Thus in case of need, all these data can be restored immediately and it is thereby easy to identify all the events in the life of a given sample.

In other words, in this way, an operator selecting a given sample can immediately have important data concerning this sample and concerning the life of this sample, that is, its record.

Thus the data stored and related to a given sample are, for example:
a description of the sample, that is, what type of biological product is involved, and an identification code or marking, for example a barcode or the like,
the identity of the persons who have handled the sample and the date when each handling took place,
the record of each operation or handling performed on the sample, for example, reception, test, freezing, storage, change in storage position, retrieval, delivery, etc.
list of all the products used for treating the sample, such as chemicals, flasks, etc., with indication, for example, of the shelf life, batch number, etc.,
precise storage location, particularly country, town, site, laboratory, room, freezer, shelf, box, etc.,
tracking record of the sample temperatures with indication of any alarm tripping (i.e. excessive temperature),
record of temperature lowering of the refrigerators, freezers, particularly the temperature gradients used to freeze the sample, and
shipment temperatures, that is, the temperature measured at the time of delivery of the sample.

Other data may also be stored in a database of the installation without necessarily being related to a given sample, for example:
alarms concerning the storage and preservation devices, such as containers, refrigerators, etc., particularly temperature, liquid nitrogen level, open/closed lid, open/closed valve alarms, etc.,
alarms concerning the other devices, such as oxygen sensors, liquid nitrogen storage reservoirs, access door to the room, web cameras, etc., particularly the alarms of oxygen content (%) or pressure in the room, identification by badge during the entry of a person into the room, etc.

Furthermore, the various alarms may be associated with a priority classification in order to identify the alarm which is the most urgent or critical.

These alarms may also be relayed by sending SMS, emails or telephone calls in order to advise the persons in real time of any malfunction of the installation.

Thanks to the present invention, it is now possible to track each sample stored precisely and effectively, and to easily retrace the record of its life in the vessel or refrigerator where it has been stored.

The present invention is particularly useful in the cryostorage of biological material of human, animal or plant origin, such as samples of cells, blood, sperm or any other similar biological material.

1. Method for monitoring and managing a cryostorage installation comprising at least one container or at least one refrigerator (3, 4), in which the samples to be stored are placed, in a refrigerated atmosphere, the said at least one container or refrigerator (3, 4) being placed in at least one room (A), in which:
a) a monitoring is carried out, preferably remotely, with gathering of one or more data issuing from or representative:
of at least one container and/or refrigerator (3, 4) containing the samples, in order to check the state of the cryogenic fluid present therein, or of the electric power supply to the said container and/or refrigerator (3, 4), of the status of the means for opening/closing the said container and/or refrigerator (3, 4), or of the temperature prevailing in the said container and/or refrigerator (3, 4),
of a cryogenic fluid feed line (2) connecting at least one reservoir (1) to at least one container and/or refrigerator (3, 4), to at least one valve arranged on the said feed line (2), or the said reservoir (118) containing the cryogenic fluid,
of at least one ambient condition prevailing in the room (A), or
of the stored samples,
and wherein at least part of the data gathered in step a) are associated with the samples and stored in a manner associated with the samples.

2. Method according to claim 1, wherein the data gathered are sent to a unit (11) of the management installation for determining the operating status of the installation and for taking action in case of malfunction.

3. Method according to claim 1, wherein the data gathered are stored in a database in which the samples are identified, listed and classed, thus creating a virtual direct link to the samples themselves.

4. Method according to claim 1, wherein a reading is made of the open or closed status of at least one valve or of a means for opening/closing the container or the refrigerator (3, 4).

5. Method according to claim 1, wherein the ambient conditions prevailing in the room (A) which are monitored in step a), are selected from the percentage of oxygen in the air of the room, the temperature in the room, the pressure in the room and the humidity of the room (A).

6. Method according to claim 1, wherein it is provided to activate an alarm when at least one of the data monitored deviates from an interval of preset values, the said alarm preferably being remotely activated by the remote management unit (11) of the installation (1).

7. Method according to claim 1, wherein, in addition, the access to the room (A) where the container (3, 4) is placed is monitored using an access indicator (60) present in the said room (A) or in its environs, or the access to the samples is monitored.

8. Method according to claim 1, wherein each biological sample or product in a cryostorage phase is associated with a code or a marking suitable for enabling its traceability.

9. Method according to claim 2, wherein the data exchanges and the communication between one or more measurement sensors and the remote management unit (11) of the installation (1) are carried out via an Internet, Ethernet or intranet network.

10. Method according to claim 1, wherein the data relative to the said monitoring are stored by the management unit (11) in order, for each sample, to permit a retrieval of the record of the biological material stored or the conditions of its storage or of the data about its handling.

11. Method according to claim 1, wherein the remote management unit (11) is suitable for acting independently on the installation (1) in order to modify at least one of the said monitored parameters or data when a disagreement or a difference is detected between the recorded data of the said parameter and the preset data.

12. Method according to claim 2, wherein it comprises the following additional step:
b) an alarm or an incident fault datum is generated when at least one of the checks of step a) identifies an irregularity or a deviation from a preset status.

13. Method according to claim 1, wherein in step a), a monitoring is carried out with gathering of one or more data issuing from or representative:
of the temperature prevailing in the said container or refrigerator (3, 4) and
of the stored samples.

14. Method according to claim 1, wherein in step a), a monitoring is carried out with gathering of a plurality of data issuing from or representative of the stored samples, the data being selected from:
a description of the sample,
an identification code or marking of the sample,
the identity of any person having handled the sample,
the date on which each sample handling has taken place,
a record of each operation or handling performed on the sample,
a list of the product(s) used to treat the sample,
the place of storage of the sample,
a record of the temperatures of the sample with indication of any alarm trip,
a record of the temperature lowerings of the refrigerators/freezers in which the sample has been stored, and
the sample shipment temperature measured at the time of delivery of the sample.

15. System for monitoring a cryostorage installation (1) comprising at least one container and/or at least one refrigerator (3, 4), in which the samples to be stored are placed, in a refrigerated atmosphere, the said at least one container and/or refrigerator (3, 4) being placed in at least one room (A), having limited and controlled access, comprising:
means (20) for monitoring each container and/or refrigerator (3, 4) containing the said samples in order to check the state of the cryogenic fluid, the temperature in the said container and/or refrigerator (3, 4), the line (2) for feeding the said cryogenic fluid connecting a reservoir (1) of cryogenic fluid to the said container and/or refrigerator (3, 4), and the said reservoir (118) of cryogenic fluid,
means for monitoring at least one ambient condition prevailing in the room (A),
and/or means for monitoring the stored samples, and
a remote management unit (11), and
data transmission means (16) suitable for sending the data relative to the said monitoring to the remote management unit (11),
and wherein the system further comprises means associating the recorded data with each sample and means for storing the data thereby recorded associated with the samples.

16. System according to claim 15, wherein the means for monitoring each container (3, 4) comprise level sensors suitable for recording the level of cryogenic fluid in the container, temperature sensors suitable for recording its temperature, and open/close sensors suitable for determining the opening of a container.

17. System according to claim 15, wherein each container is associated with an identification and control device (20) connected to at least one of the said sensors and to at least one control unit remotely connected to the remote management unit (11) of the installation (1).

18. System according to claim 17, wherein two redundant control units are provided, connected to a data transfer line to which the identification and control device (20) is also connected.

19. System according to claim 15, wherein, in the room (A), measurement means (6) are provided for measuring the ambient conditions, particularly of the ambient air, preferably means (7) are also provided for ventilating the said room, activable according to the recording of such conditions.

20. System according to claim 19, wherein the measurement means (6) are selected from an air pressure sensor, a temperature and/or humidity sensor, and a sensor of the oxygen content in the air of the room (A) where the cryostorage containers (3, 4) are placed.

21. System according to claim 19, wherein the measurement means (6) are connected to the remote management unit (11) of the installation.

22. System according to claim 15, wherein the remote management unit (11) of the installation is connected to at least one server (12) suitable for gathering the data recorded in the containers (3, 4) and/or in the room (A) where they are placed.

23. System according to claim 15, wherein the remote management unit (11) is connected to the server via a network connection.

24. System according to claim 15, wherein the data transmission means (16) are designed and suitable for sending the data relative to the said monitoring, to the remote management unit (11) in order to determine the operating status of the cryostorage installation and take action in case of malfunction or if the recorded data are different from the corresponding preset data.

25. System according to claim 15, wherein it further comprises alarm means designed and able to trip an alarm or to deliver an incident fault datum when at least one of the checks performed by the remote management unit (11) identifies an irregularity or a deviation from a preset state.
